(19) United States
(12) Patent Application Publication
(10) Pub. No.: US 2016/0210936 A1
(43) Pub. Date: Jul. 21, 2016

(54) LUMINANCE CORRECTION DEVICE, IMAGE DISPLAY DEVICE, AND LUMINANCE CORRECTION METHOD

(71) Applicants: KABUSHIKI KAISHA TOSHIBA, Tokyo (JP); TOSHIBA LIFESTYLE PRODUCTS & SERVICES CORPORATION, Ome Tokyo (JP)

(72) Inventors: Masayuki Tokunaga, Tachikawa Tokyo (JP); Yoshiharu Momonoi, Yokohama Kanagawa (JP)

(21) Appl. No.: 14/923,008

(22) Filed: Oct. 26, 2015

(30) Foreign Application Priority Data
Jan. 15, 2015 (JP) 2015-006189

(51) Int. Cl. G09G 5/10; G09G 3/20

(52) U.S. Cl. CPC G09G 5/10; G09G 3/20; G09G 2320/0233

(57) ABSTRACT

A luminance correction device according to the present embodiment is used for an image display device comprising a display part displaying an image, a frame part provided at an outer edge of the display part, and a lens part provided across a boundary part between the display part and the frame part and to face the display part. The luminance correction device comprises an input part, a correction coefficient generator, a luminance corrector, and an output part. The input part inputs an input luminance value. The correction coefficient generator generates a correction coefficient based on the input luminance value. The luminance corrector calculates an output luminance value by multiplying the input luminance value by the correction coefficient. The output part outputs the output luminance value to the display part.

### CROSS REFERENCE TO RELATED APPLICATIONS

This application is based upon and claims the benefit of priority from the prior Japanese Patent Application No. 2015-6189, filed on Jan. 15, 2015, the entire contents of which are incorporated herein by reference.

### FIELD

Embodiments of the present invention relate to a luminance correction device, an image display device, and a luminance correction method.

### BACKGROUND

There is a technique that enables the frame of a display to be less noticeable by placing a lens in front of the display (so-called “frameless tiling technique”). This technique has a problem that pixels viewed through the lens (that is, pixels arranged near the frame) appear darker than other pixels.

Luminance correction processing is used as means for addressing this problem. The luminance correction processing is processing to set the luminance values of pixels that are viewed through the lens to be larger than those of other pixels, thereby enabling the pixels viewed through the lens to appear with the same brightness as that of other pixels. In the luminance correction processing, an input luminance value of each of pixels input to the display is multiplied by a correction coefficient for each of the pixels. Specifically, the input luminance values of the pixels viewed through the lens are multiplied by larger correction coefficients and the input luminance values of other pixels are multiplied by smaller correction coefficients, respectively.

However, the conventional luminance correction processing has a problem that when the input luminance values are small (that is, low), the pixels viewed through the lens appear brighter than other pixels, which leads to so-called “black floating” or a reduced gradation.

### BRIEF DESCRIPTION OF THE DRAWINGS

FIG. 1 is a schematic front view of an image display system 1 according to the present embodiment;

FIG. 2 is a schematic cross-sectional view along a line 2-2 in FIG. 1;

FIG. 3 is a block diagram of a luminance correction device 15 in the image display system 1 shown in FIG. 1;

FIG. 4 is a flowchart showing an operation example of the luminance correction device 15;

FIG. 5 is a graph showing an example of a correction coefficient;

FIG. 6 is a schematic diagram showing an example of the correction coefficient;

FIGS. 7A and 7B are graphs showing modifications of the correction coefficient; and

FIG. 8 is a schematic front view showing a modification of a lens part 141.

### DETAILED DESCRIPTION

A luminance correction device according to the present embodiment is used for an image display device comprising a display part displaying an image, a frame part provided at an outer edge of the display part, and a lens part provided across a boundary part between the display part and the frame part and to face the display part. The luminance correction device comprises an input part, a correction coefficient generator, a luminance corrector, and an output part. The input part inputs an input luminance value. The correction coefficient generator generates a correction coefficient based on the input luminance value. The luminance corrector calculates an output luminance value by multiplying the input luminance value by the correction coefficient. The output part outputs the output luminance value to the display part.

Embodiments will now be explained with reference to the accompanying drawings. The present invention is not limited to the embodiments.

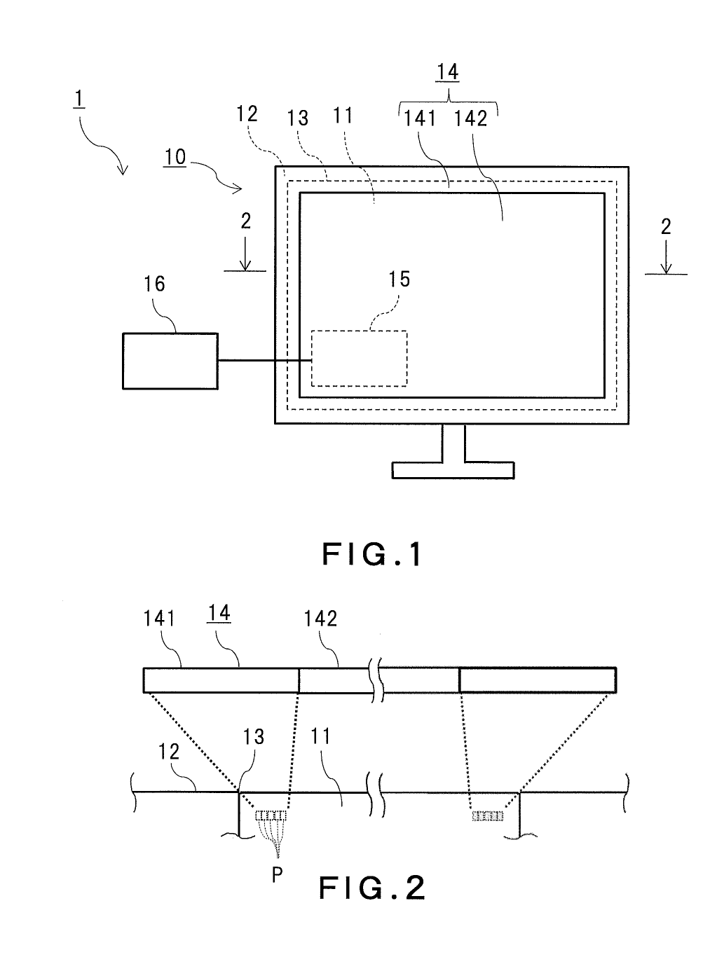

FIG. 1 is a schematic front view of an image display system 1 according to the present embodiment. FIG. 2 is a schematic cross-sectional view along a line 2-2 in FIG. 1.

As shown in FIG. 1, the image display system 1 includes an image display device 10 and an input-image generation device 16. The image display device 10 includes a display part 11, a frame part 12, a lens plate 14, and a luminance correction device 15. The lens plate 14 includes a lens part 141 and a non-lens part 142.

Image Display Device 10

The image display device 10 is connected to the input-image generation device 16 wiredly or wirelessly. The input-image generation device 16 generates first image data having input luminance values of a plurality of pixels. The input-image generation device 16 outputs the generated first image data to the image display device 10. The image display device 10 generates second image data (described later) based on the first image data input from the input-image generation device 16. The image display device 10 displays an image (a video) corresponding to the generated second image data on the display part 11.

The input-image generation device 16 is, for example, a DVD player. Alternatively, the input-image generation device 16 can be a blu-ray disc player, a hard disk drive, or a server on an external network. The display part 11 is, for example, a liquid crystal panel. Alternatively, the display part 11 can be a plasma display panel or an organic electroluminescence display panel.

The input-image generation device 16 preferably generates the first image data in consideration of the magnification of the lens part 141 of the lens plate 14. Specifically, in anticipation of enlargement of an image in the lens part 141, it is preferable that the input-image generation device 16 cause an image optically coupled to the lens part 141 to be an image having a smaller display area than that of an image optically coupled to the non-lens part 142. By thus generating the first image data in consideration of the magnification of the lens part 141, an image viewed through the lens part 141 can be prevented from becoming larger than an image viewed through the non-lens part 142. This can enhance visibility of an image.

The frame part 12 is provided at an outer edge of the display part 11. While being an inevitable component to hold the display part 11, the frame part 12 may degrade the visibility of an image because the frame part 12 is located at the outer edge of the display part 11. Accordingly, the image display device 10 includes the lens part 141 to cause the frame part 12 to be less noticeable to a viewer.

As shown in FIG. 2, the lens part 141 is provided across a boundary part 13, that is, a boundary line between the display part 11 and the frame part 12. The lens part 141 is provided at a position on a viewing side (a front side) with respect to the display part 11 to face the display part 11.

Outgoing light from pixels P arranged near the frame part 12 among pixels of the display part 11 enters the lens part 141. That is, the pixels P are optically coupled to the lens part 141.

The lens part 141 refracts the outgoing light from the pixels P toward the viewing side. Due to refraction of the outgoing light from the pixels P at the lens part 141, a user can view an image through the lens part 141 on the area of the frame part 12 on which no image is originally displayed. In this manner, the frame part 12 can be caused to be less noticeable.

The lens part 141 is provided at an outer edge of the non-lens part 142 integrally with the non-lens part 142. The non-lens part 142 is formed of a transparent material in a plate shape having a uniform thickness. Unlike the lens part 141, the non-lens part 142 does not have intentional refractive power.

A specific mode of the lens plate 14 is not limited to that described above and the lens plate 14 can be formed, for example, by bonding the lens part 141 to an outer periphery of a glass flat plate (the non-lens part 142) having a rectangular plane shape. The lens part 141 can be an aspheric lens or a bonded lens, for example.

As described above, the lens part 141 can cause the frame part 12 to be less noticeable and thus can improve the visibility of an image. However, with provision of the lens part 141 alone, the image optically coupled to the lens part 141 (that is, the image viewed through the lens part 141) appears darker than the image optically coupled to the non-lens part 142 (that is, the image viewed through the non-lens part 142). When an apparent brightness of the image optically coupled to the lens part 141 is thus reduced, the gradation is degraded.

Accordingly, the image display device 10 includes the luminance correction device 15 to provide a satisfactory gradation even when the lens part 141 is provided. The luminance correction device 15 is, for example, a gamma correction circuit that corrects input luminance values (brightness) of pixels by λ correction. The luminance correction device 15 can be any electronic device other than the gamma correction circuit as long as it is hardware that can correct the input luminance values. The luminance correction device 15 can be configured by software as well as the hardware.

Luminance Correction Device 15

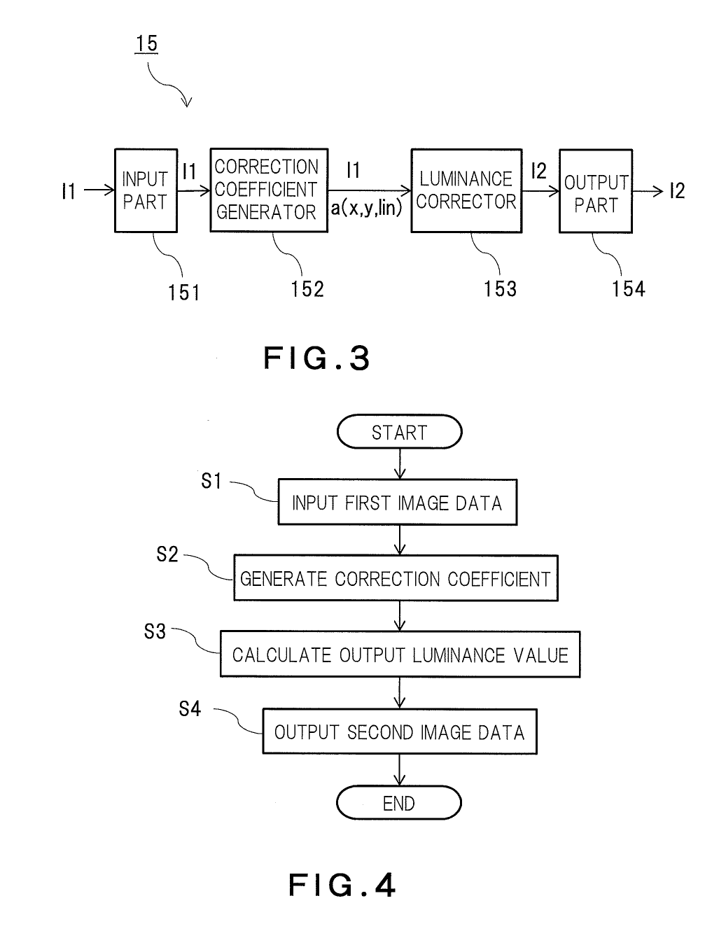

FIG. 3 is a block diagram of the luminance correction device 15 in the image display system 1 shown in FIG. 1. As shown in FIG. 3, the luminance correction device 15 includes an input part 151, a correction coefficient generator 152, a luminance corrector 153, and an output part 154.

First image data I1 is input from the input-image generation device 16 to the input part 151. As described above, the first image data I1 has input luminance values lin of plural pixels. The input part 151 outputs the first image data I1 to the correction coefficient generator 152.

The first image data I1 is input from the input part 151 to the correction coefficient generator 152. The correction coefficient generator 152 generates correction coefficients a(x, y, lin) based on the input luminance values lin of the first image data I1 and the positions, that is, coordinates (x, y) of pixels. The correction coefficient generator 152 generates smaller values as the correction coefficients a(x, y, lin) for the pixels P optically coupled to the lens part 141 as the input luminance values lin are smaller. The correction coefficient generator 152 outputs the generated correction coefficients a(x, y, lin) and the first image data I1 to the luminance corrector 153.

The correction coefficients a(x, y, lin) and the first image data I1 are input from the correction coefficient generator 152 to the luminance corrector 153. The luminance corrector 153 can alternatively receive the first image data I1 from the input part 151. The luminance corrector 153 calculates output luminance values lout based on the correction coefficients a(x, y, lin) and the first image data I1. Specifically, the luminance corrector 153 calculates the output luminance values lout by multiplying the input luminance values lin of the first image data I1 by the correction coefficients a(x, y, lin), respectively. That is, the output luminance values lout satisfy the following expression.

lout=a(x, y, lin)×lin (1)

The luminance corrector 153 generates second image data I2 based on the calculated output luminance values lout. The second image data I2 is image data obtained by correcting at least the input luminance values of the pixels P optically coupled to the lens part 141 in the first image data I1 using the correction coefficients. That is, the second image data I2 is image data obtained by luminance correction processing for the first image data I1. In still other words, the second image data I2 is image data having output luminance values of plural pixels. The luminance corrector 153 outputs the generated second image data I2 to the output part 154.

The output part 154 outputs the second image data I2 input from the luminance corrector 153 to the display part I1.

Because having a lower directivity and being more likely to diffuse than outgoing light from a pixel having a larger luminance value, outgoing light from a pixel having a smaller luminance value is likely to concentrate on the lens part 141 on a peripheral side of the display part 11.

Therefore, if luminance correction processing is performed using a correction coefficient calculated in consideration of only the positions of pixels in a situation where the input luminance values lin of the first image data I1 are small, the pixels P optically coupled to the lens part 141 appear brighter than the pixels optically coupled to the non-lens part 142.

That is, black floating occurs near the boundary part 13 between the display part 11 and the frame part 12. The black floating is more remarkable when a viewer obliquely views the display part 11.

On the other hand, the correction coefficients a(x, y, lin) according the present embodiment are obtained in consideration of the input luminance values lin as well as the positions (x, y) of pixels. Specifically, as described above, the correction coefficients a(x, y, lin) have smaller values as the input luminance values lin are smaller.

Therefore, by using the correction coefficients a(x, y, lin), the amount of increase in the luminance values of the pixels P due to the luminance correction processing in the case where the input luminance values lin are small can be set to be smaller than that in the case where the input luminance values lin are large. By thus suppressing increase in the luminance values of the pixels P when the input luminance values lin are small, black floating can be suppressed. As a result of suppression of the black floating, the gradation can be improved.

Luminance Correction Processing

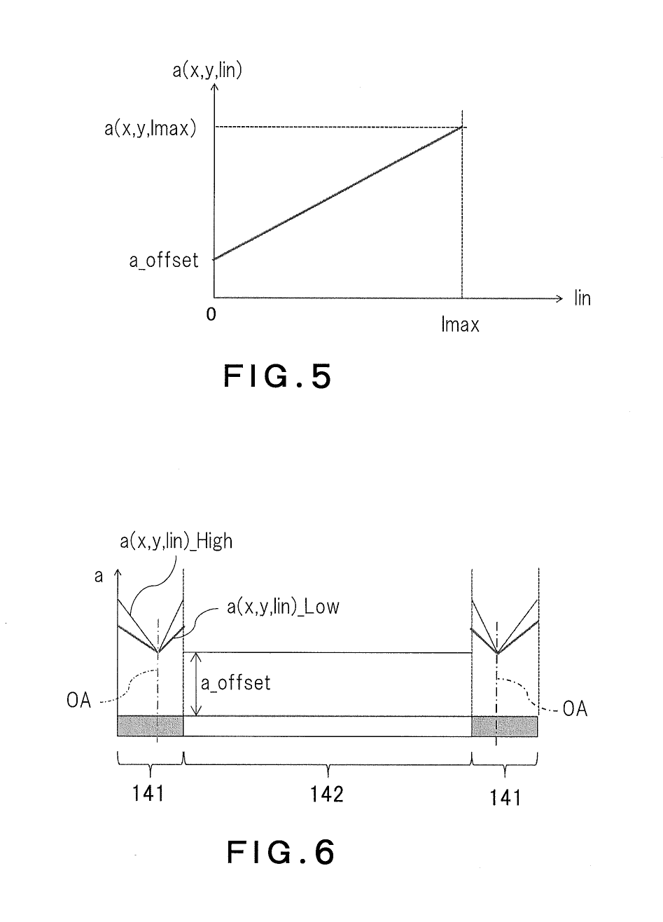

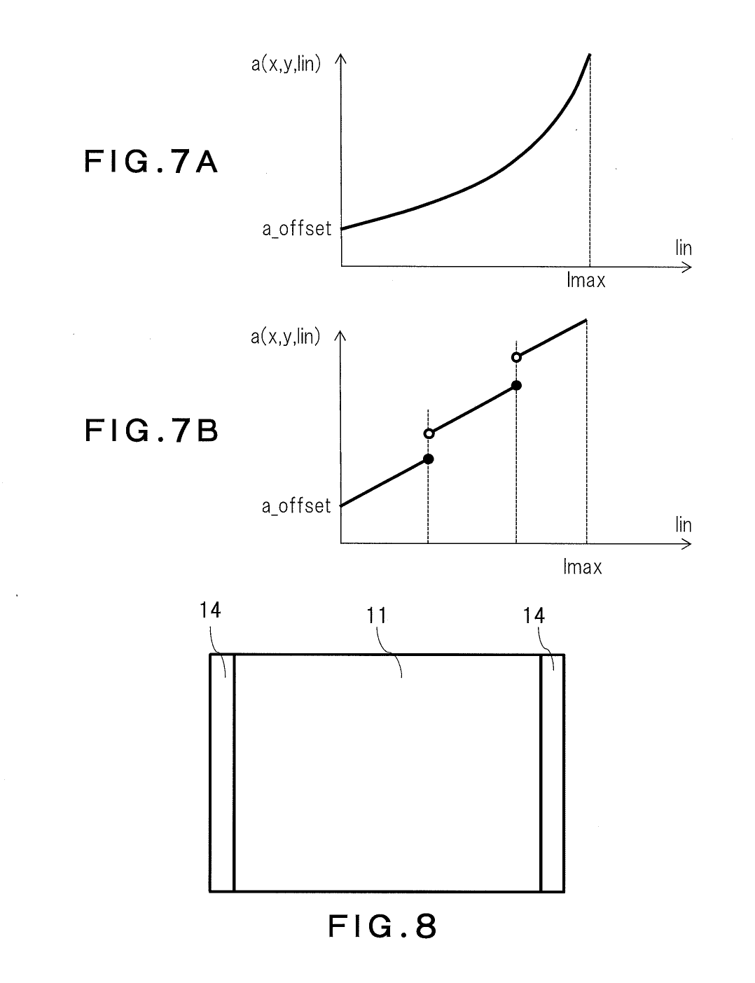

The luminance correction processing as an operation example of the luminance correction device 15 is explained next with reference to FIGS. 4 to 7. FIG. 4 is a flowchart showing an operation example of the luminance correction device 15. FIG. 5 is a graph showing an example of a correction coefficient. FIG. 6 is a schematic diagram showing an example of the correction coefficient. FIGS. 7A and 7B are graphs showing modifications of the correction coefficient.

First, the input part 151 inputs the first image data I1 from the input-image generation device 16 (Step S1).

Next, the correction coefficient generator 152 generates the correction coefficients a(x, y, lin) based on the input luminance values lin of the first image data I1 and the positions (x, y) of pixels (Step S2).

For example, the correction coefficient generator 152 generates the correction coefficients a(x, y, lin) based on a monotonically increasing function having the input luminance values lin as an argument. In this case, the monotonically increasing function is given by the following expression (2), for example.

a(x, y, lin)=lin/lmax(a(x, y, lmax)−a_offset)+a_offset (2)

In the expression (2), x denotes an x coordinate of the display part 11 and y denotes a y coordinate of the display part 11. Furthermore, lin denotes an input luminance value, lmax denotes the maximum value of the input luminance value, and a_offset denotes an offset value. In the right-hand side of the expression (2), lin is a variable and lmax, a(x, y, lmax), and a_offset are constants.

FIG. 5 is a graph showing the expression (2). As shown in FIG. 5, the correction coefficient a(x, y, lin) of the expression (2) are a linear function linearly increasing with increase in the input luminance value lin.

FIG. 6 shows correction coefficients differing depending on the positions of pixels as an application example of the expression (2). In FIG. 6, a correction coefficient a(x, y, lin)_High in a case where the input luminance values lin of all pixels are a fixed high luminance value and a correction coefficient a(x, y, lin)_Low in a case where the input luminance values lin of all pixels are a fixed low luminance value are shown.

As shown in FIG. 6, an offset value a_offset of the correction coefficient a(x, y, lin)_High in the case of a high luminance and an offset value a_offset of the correction coefficient a(x, y, lin)_Low in the case of a low luminance are both equal to a correction coefficient of pixels on an optical axis OA of the lens part 141. Furthermore, the correction coefficient of the pixels on the optical axis OA of the lens part 141 is equal to a correction coefficient a_offset of the pixels optically coupled to the non-lens part 142.

The correction coefficient a(x, y, lin)_High in the case of a high luminance and the correction coefficient a(x, y, lin)_Low in the case of a low luminance are both larger for pixels more distant from the pixels on the optical axis OA. The reason is that outgoing light from pixels more distant from the pixels on the optical axis OA is refracted at the lens part 141 in a direction more distant from the direction of the optical axis OA (the viewing side) and thus appears darker on the viewing side. In anticipation of this reduction in the apparent brightness, a larger correction coefficient is set for a pixel more distant from the pixels on the optical axis OA, thereby enabling suppression of variations in the brightness depending on the positions of pixels.

Meanwhile, the correction coefficient a(x, y, lin)_High in the case of a high luminance and the correction coefficient a(x, y, lin)_Low in the case of a low luminance are different in the amount of increase (that is, the inclination) of the luminance value with separation from the pixels on the optical axis OA. Specifically, the amount of increase of the correction coefficient a(x, y, lin)_Low in the case of a low luminance is smaller than that of the correction coefficient a(x, y, lin)_High in the case of a high luminance. This is because the correction coefficients satisfying the expression (2) are adopted as the correction coefficients for the pixels optically coupled to the lens part 141 (except for the pixels on the optical axis OA). As shown in FIG. 6, the correction coefficients a(x, y, lin)_High and a(x, y, lin)_Low are set to be larger for pixels more distant from the pixels on the optical axis OA and to cause the amounts of increase of the luminance value with separation from the pixels on the optical axis OA to be different from each other. Accordingly, black floating in the case of a low luminance can be suppressed while variations in the brightness depending on the positions of the pixels are suppressed.

While the luminance values of all the pixels are fixed in FIG. 6 for convenience sake, the black floating can be suppressed by using the correction coefficients a(x, y, lin) satisfying the expression (2) also when the luminance values of the pixels are different. Furthermore, the offset value a_offset of the correction coefficient a(x, y, lin)_High in the case of a high luminance can be different from the offset value a_offset of the correction coefficient a(x, y, lin)_Low in the case of a low luminance. The correction coefficient for the pixels on the optical axis OA of the lens part 141 can be different from that for the pixels optically coupled to the non-lens part 142. The offset value a_offset can differ depending on the positions of pixels.

Subsequently, as shown in FIG. 4, the luminance corrector 153 calculates the output luminance values lout based on the correction coefficients (Step S3). The luminance corrector 153 generates the second image data I2 having the output luminance values lout.

Next, the output part 154 outputs the second image data I2 to the display part 11 (Step S4).

As explained above, according to the present embodiment, black floating in the case where the input luminance values lin are small can be suppressed by performing the luminance correction processing using the correction coefficients a(x, y, lin) in consideration of the input luminance values lin.

The image display device 10 according to the present embodiment can be effectively applied also to a case where a plurality of the display parts 11 are arranged to provide large-scale display. Specifically, when large-scale display is provided by arranging the display parts 11 adjacently in a matrix, high-gradation display that causes seams between the display parts 11 and black floating to be less noticeable can be realized.

Modification

Modifications of the present embodiment are explained next. FIGS. 7A and 7B are graphs showing modifications of the correction coefficient. FIG. 8 is a front view showing a modification of the lens part 141.

The correction coefficients a(x, y, lin) shown in FIG. 5 are a continuous linear function as a monotonically increasing function. However, the mode of the monotonically increasing function is not limited to that shown in FIG. 5. For example, the monotonically increasing function can be a quadratic function that is concave downwardly as shown in FIG. 7A. Alternatively, the monotonically increasing function can be a discontinuous function as shown in FIG. 7B. Also when the luminance correction processing is performed using the correction coefficients shown in FIG. 7A or 7B, an identical effect to that in the case of using the correction coefficients shown in FIG. 5 can be achieved.

While the lens part 141 shown in FIG. 1 has a frame shape, the mode of the lens part 141 is not limited to that shown in FIG. 1. For example, the lens part 141 can be provided only at right and left ends of the display part 11 as shown in FIG. 8.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A luminance correction device used for an image display device comprising a display part displaying an image, a frame part provided at an outer edge of the display part, and a lens part provided across a boundary part between the display part and the frame part and to face the display part, the luminance correction device comprising:
an input part inputting an input luminance value;
a correction coefficient generator generating a correction coefficient based on the input luminance value;
a luminance corrector calculating an output luminance value by multiplying the input luminance value by the correction coefficient; and
an output part outputting the output luminance value to the display part.

2. The device of claim 1, wherein the correction coefficient generator generates a smaller value as the correction coefficient as the input luminance value is smaller.

3. The device of claim 2, wherein the correction coefficient generator generates the correction coefficient based on a monotonically increasing function having the input luminance value as an argument.

4. The device of claim 3, wherein the monotonically increasing function is a quadratic function being concave downwardly or a discontinuous function.

5. The device of claim 3, wherein the monotonically increasing function is given by a following expression (1):
a(x, y, lin)=lin/lmax(a(x, y, lmax)−a_offset)+a_offset (1)
where x is an x coordinate of the display part, y is a y coordinate of the display part, lin is an input luminance value, lmax is a maximum value of the input luminance value, and a_offset is an offset value.

6. The device of claim 1, wherein
the input part inputs first image data having input luminance values of a plurality of pixels, and
the output part outputs to the display part, second image data obtained by correcting at least input luminance values of pixels optically coupled to the lens part in the first image data using the correction coefficient.

7. The device of claim 6, wherein the correction coefficient generator generates the correction coefficient based on the input luminance values and positions of the pixels.

8. The device of claim 6, wherein the correction coefficient generator generates a larger value as the correction coefficient for a pixel more distant from pixels on an optical axis of the lens part.

9. An image display device comprising:
a display part displaying an image;
a frame part provided at an outer edge of the display part;
a lens part provided across a boundary part between the display part and the frame part and to face the display part; and
a luminance correction device correcting an input luminance value, wherein
the luminance correction device comprises:
an input part inputting the input luminance value;
a correction coefficient generator generating a correction coefficient based on the input luminance value;
a luminance corrector calculating an output luminance value by multiplying the input luminance value by the correction coefficient; and
an output part outputting the output luminance value to the display part.

10. The device of claim 9, wherein the correction coefficient generator generates a smaller value as the correction coefficient as the input luminance value is smaller.

11. The device of claim 10, wherein the correction coefficient generator generates the correction coefficient based on a monotonically increasing function having the input luminance value as an argument.

12. The device of claim 11, wherein the monotonically increasing function is a quadratic function being concave downwardly or a discontinuous function.

13. The device of claim 11, wherein
the monotonically increasing function is given by a following expression (1):
a(x, y, lin)=lin/lmax(a(x, y, lmax)−a_offset)+a_offset (1)
where x is an x coordinate of the display part, y is a y coordinate of the display part, lin is an input luminance value, lmax is a maximum value of the input luminance value, and a_offset is an offset value.

14. The device of claim 9, wherein
the input part inputs first image data having input luminance values of a plurality of pixels, and
the output part outputs to the display part, second image data obtained by correcting at least input luminance values of pixels optically coupled to the lens part in the first image data using the correction coefficient.

15. The device of claim 14, wherein the correction coefficient generator generates the correction coefficient based on the input luminance values and positions of the pixels.

16. The device of claim 14, wherein the correction coefficient generator generates a larger value as the correction coefficient for a pixel more distant from pixels on an optical axis of the lens part.

17. A luminance correction method performed in an image display device comprising a display part displaying an image, a frame part provided at an outer edge of the display part, and a lens part provided across a boundary part between the display part and the frame part and to face the display part, the method comprising:
inputting an input luminance value;
generating a correction coefficient based on the input luminance value;
calculating an output luminance value by multiplying the input luminance value by the correction coefficient; and
outputting the output luminance value to the display part.

18. The method of claim 17, wherein a smaller value is generated as the correction coefficient as the input luminance value is smaller.

19. The method of claim 18, wherein the correction coefficient is generated based on a monotonically increasing function having the input luminance value as an argument.

20. The method of claim 19, wherein the monotonically increasing function is a quadratic function being concave downwardly or a discontinuous function.
